(19) United States
(12) Patent Application Publication
(10) Pub. No.: US 2011/0154793 A1
(43) Pub. Date: Jun. 30, 2011

(54) FORAGE CHOPPER HEADER FOR HARVESTING BOTH STANDING AND DOWN CROP MATERIAL

(76) Inventor: Curtis Ernst, Mankato, KS (US)

(21) Appl. No.: 12/980,625

(22) Filed: Dec. 29, 2010

Related U.S. Application Data
(60) Provisional application No. 61/291,291, filed on Dec. 30, 2009.

(51) Int. Cl. A01D 45/00

(52) U.S. Cl. 56/94

(57) ABSTRACT

A forage chopper header is provided for use with a forage harvester having a mechanism for chopping crop material and conveying the chopped crop material into a transport vehicle. The header includes a plurality of rotary cutters arranged side-by-side across a front side of a platform, a first auger arranged for conveying crop material cut by the rotary cutters from an outer portion of the header toward the center portion thereof, and a roller supported at a front side of the header and extending across a width of the header for engaging and bending standing crop material as the crop material enters the header. A crop gathering arm assembly can be positioned in front of the roller to help guide standing crop material into the header. A second auger can be arranged in front of the first auger to prevent bunching of crop material in front of the rotary cutters.

### RELATED APPLICATIONS

This application claims priority of U.S. Provisional Application No. 61/291,291 filed on Dec. 30, 2009. The content of this prior application is incorporated herein by reference.

### BACKGROUND OF THE INVENTION

1. Field of the Invention

The present invention relates generally to agricultural harvesters, and in particular, to forage choppers that have a header for gathering and cutting crop material from a field.

2. Description of the Related Art

Forage harvesters are known in the art and have been used for many years to harvest standing crop material from a field for use as livestock feed and the like. Conventional forage harvesters have a header for gathering and cutting the crop material, a chopping mechanism for chopping the crop material into small pieces, and a discharge spout for conveying the chopped crop material into a transport vehicle operating alongside or towed by the harvester. Modern forage harvesters are typically self-propelled, although towed forage harvesters are still occasionally used.

Conventional headers for forage harvesters have a complex arrangement of cutter drums and blades for cutting and conveying crop material to the chopper mechanism. For example, U.S. Pat. No. 6,826,897 of Wubbels discloses a header for a crop harvester that uses a series of side-by-side mowing drums and intake drums to cut and convey crop material to the chopper mechanism of the harvester. The Wubbels header and others like it work fairly well when harvesting standing crop material and when the machine is adequately maintained. However, the mowing drums and intake drums of Wubbels header include a large number of moving parts that require substantial maintenance and repair to keep the machine operating during normal harvesting conditions. In addition, the mowing drums do not work well in picking up and cutting crop material that is in a down and entangled position, such as weathered and damaged forage crops.

There is a need for an improved header for forage harvesters to harvest both standing and down crop material.

### SUMMARY OF THE INVENTION

It is an object of the present invention to provide a header for forage harvesters that has the ability to efficiently harvest standing crops, wind-row crops, and tangled and down crops.

It is a further object of the present invention to provide a forage harvester header that will recover more material from a field by cutting lower to the ground than conventional headers.

It is a further object of the present invention to provide a forage harvester header that is affordable to manufacture, reliable in operation, uses fewer moving parts, uses less horsepower and fuel, and does not require as much maintenance as conventional forage harvester headers.

It is a further object of the present invention to provide a forage harvester header with a self-contained hydraulic power unit that allows the use of multiple hydraulic motors for powering the header without over-burdening the hydraulic systems of existing forage harvesters.

To accomplish these and other objects of the present invention, a forage chopper header is provided for use with a forage harvester having a mechanism for chopping crop material and conveying the chopped crop material into a transport vehicle. The header includes a plurality of rotary cutters arranged side-by-side across a front side of a platform, a first auger arranged for conveying crop material cut by the rotary cutters from an outer portion of the header toward the center portion thereof, and a roller supported at a front side of the header and extending across a width of the header for engaging and bending standing crop material as the crop material enters the header. A crop gathering arm assembly can be positioned in front of the roller to help guide standing crop material into the header. A second auger can be arranged in front of the first auger to prevent bunching of crop material in front of the rotary cutters.

According to one aspect of the present invention, a header for a forage harvester is provided, comprising: a plurality of rotary cutters arranged side-by-side across a front side of a platform, the platform having a rear discharge opening at a center portion of the header for passing crop material to a chopper mechanism; a first auger arranged for conveying crop material cut by the rotary cutters from an outer portion of the header toward the center portion thereof, the first auger being rotatably driven about a first generally transverse horizontal axis; and a roller supported at a front side of the header and extending across a width of the header for engaging and bending standing crop material as the crop material enters the header.

Numerous other objects of the present invention will be apparent to those skilled in this art from the following description wherein there is shown and described an example embodiment of the present invention. As will be realized, the invention is capable of other different embodiments, and its several details are capable of modification in various obvious aspects without departing from the invention. Accordingly, the drawings and description should be regarded as illustrative in nature and not restrictive.

### BRIEF DESCRIPTION OF THE DRAWINGS

The present invention will become more clearly appreciated as the disclosure of the present invention is made with reference to the accompanying drawings. In the drawings:

FIG. 1 is a perspective view of a forage harvester header according to the present invention.

FIG. 2 is a plan view of the forage harvester header shown in FIG. 1.

FIG. 3 is a front view of the forage harvester header shown in FIG. 1.

FIG. 4 is a side view of an adjustable crop gathering roller used with the header of the present invention.

FIG. 5 is a side view of the header showing a crop gathering arm, crop gathering roller, cutter head mechanism, and first and second conveying augers.

FIG. 6 is a side view of the header with the components shown in FIG. 5 moved to a raised position for adapting to different crop conditions.

FIG. 7 is a side view of the header attached to a forage harvester.

FIG. 8 is a side view of the header removed from the forage harvester.

FIG. 9 is a perspective view of the forage harvester header shown in FIG. 1 with crop material being cut and moving through the header.

FIG. 10 is a plan view of a forage harvester header according to another embodiment in which guards are installed to float crop material over the rotary cutters.

FIG. 11 is a front view of the forage harvester header shown in FIG. 10.

FIG. 12 is a detail side view of the forage harvester header shown in FIG. 10.

FIG. 13 is a side view of a forage harvester with the header shown in FIG. 10 detached therefrom.

### DETAILED DESCRIPTION OF THE INVENTION

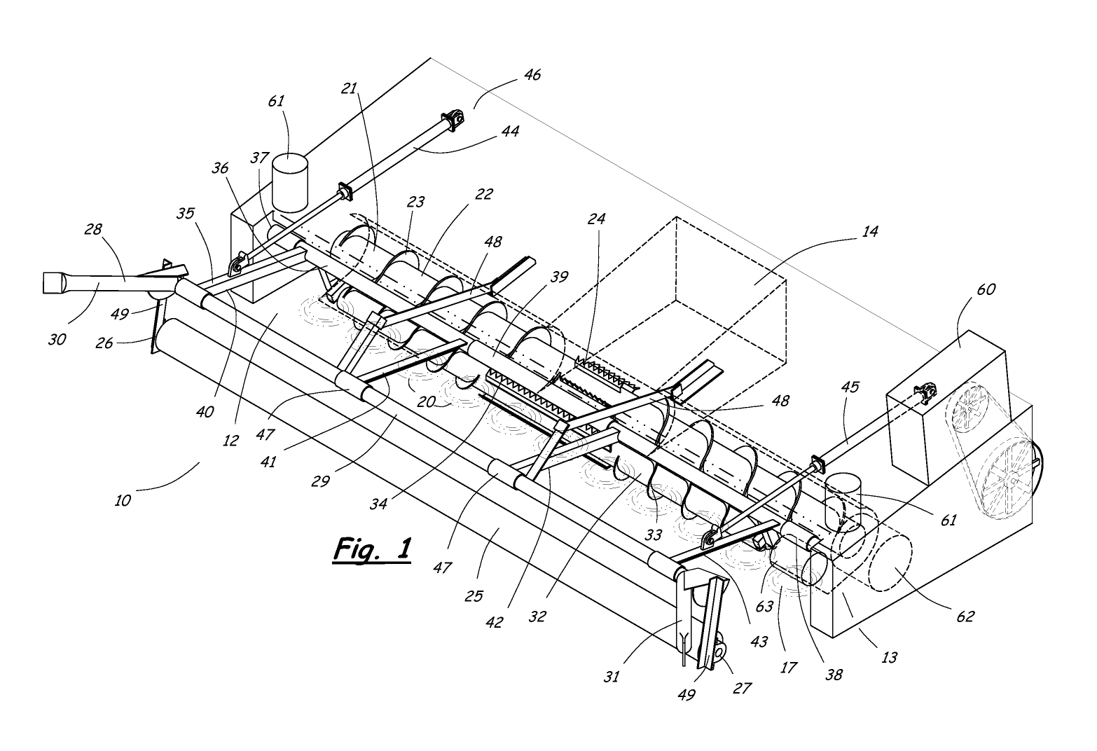

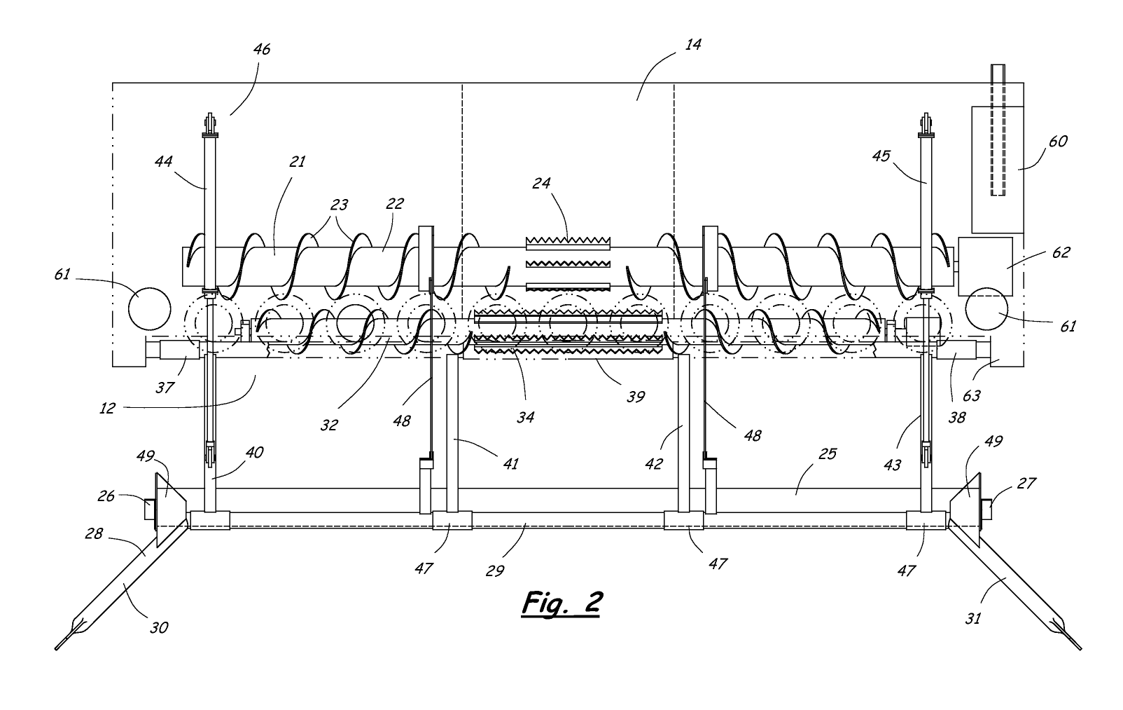

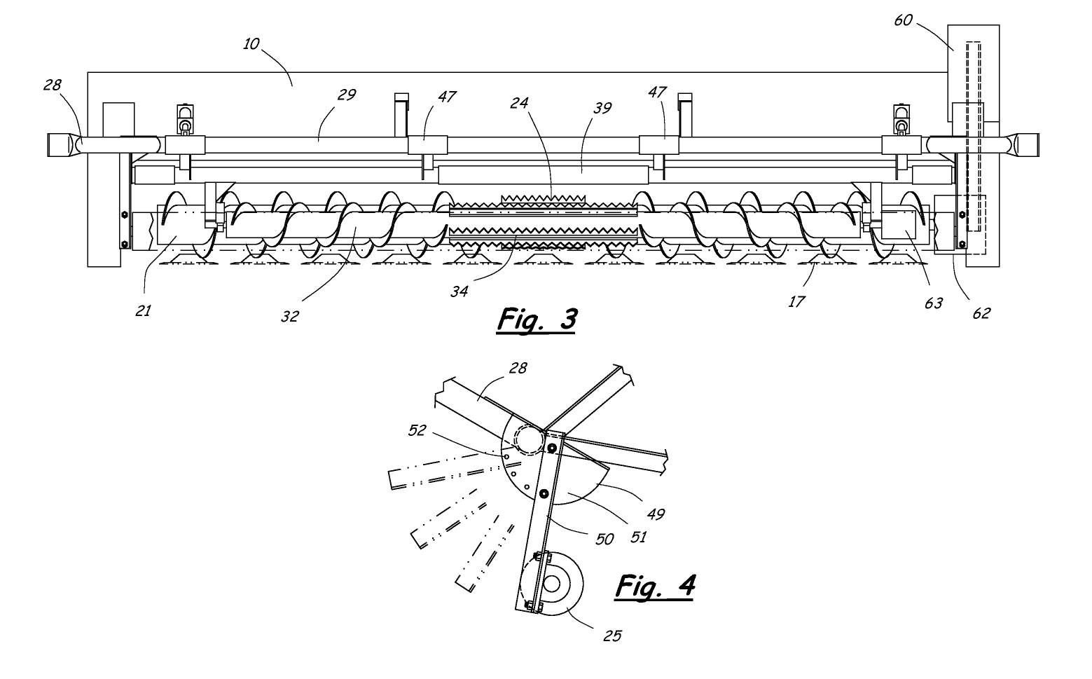

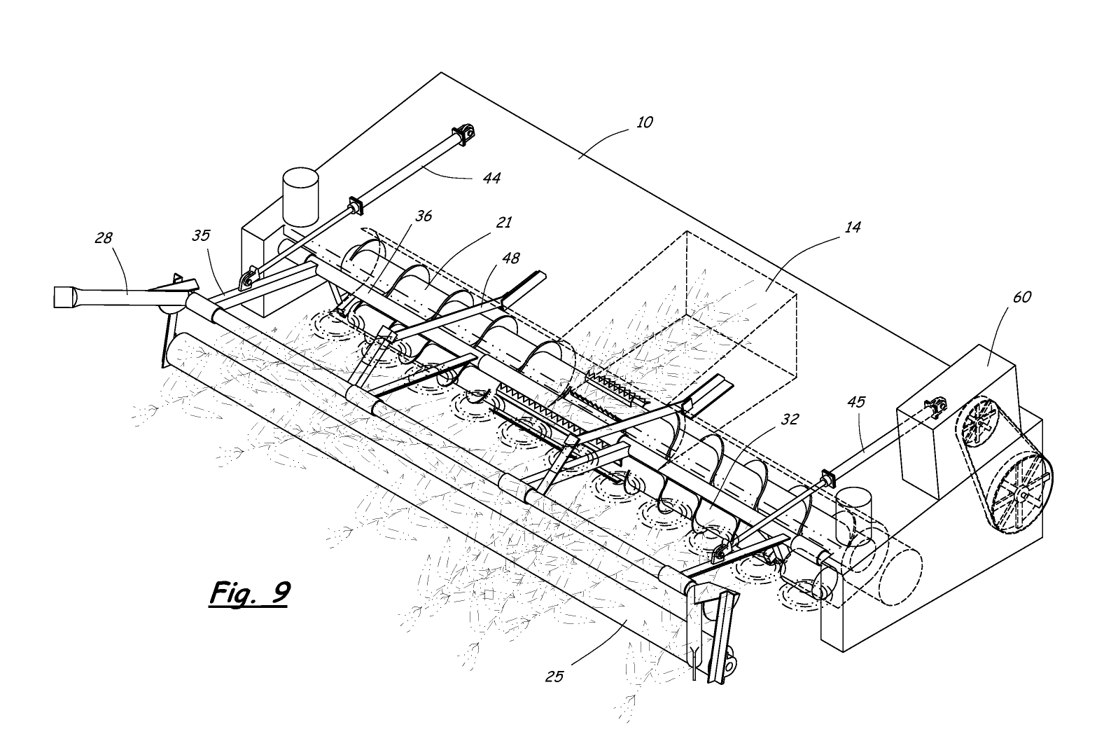

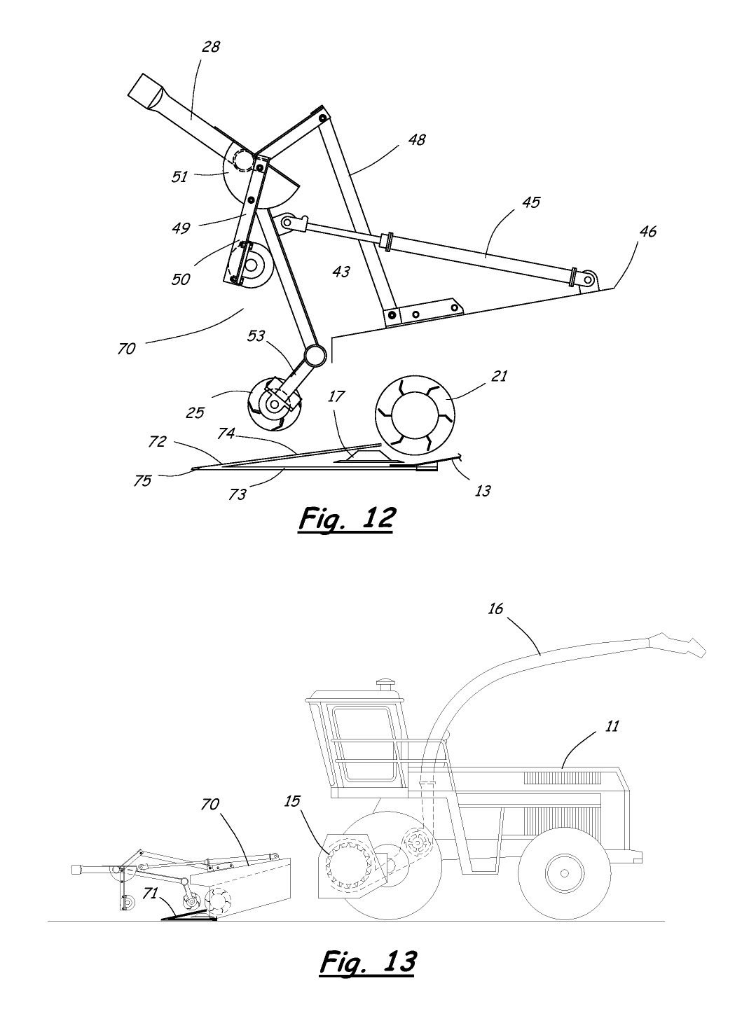

A forage harvester header according to embodiments of the present invention will now be described in detail with reference to FIGS. 1 to 13 of the accompanying drawings.

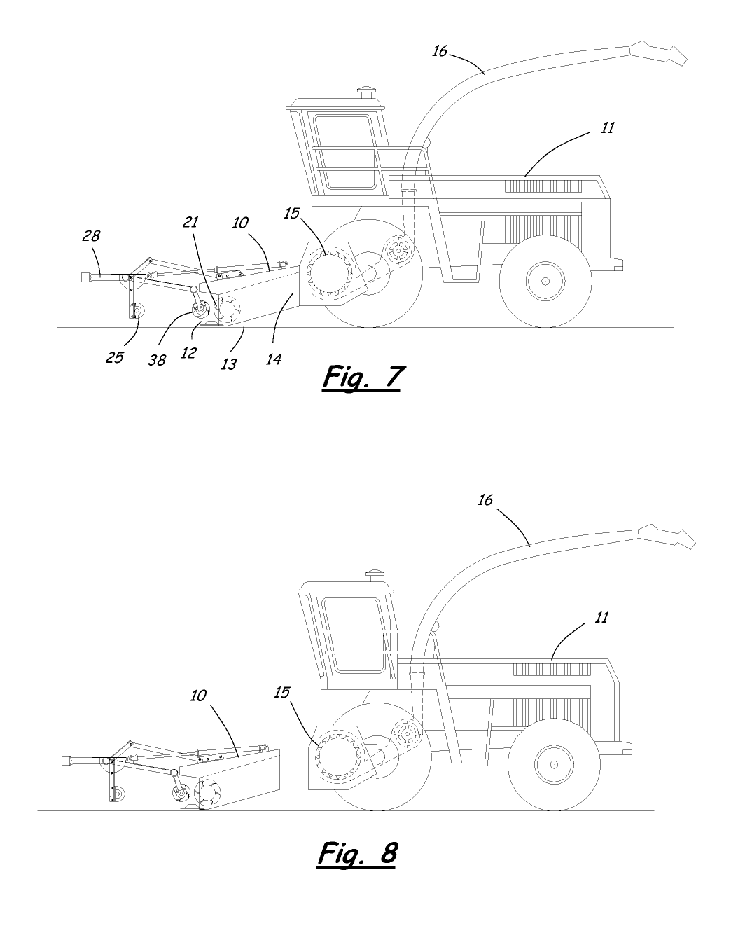

The forage chopper header 10 of the present invention is shown in perspective, plan and front views in FIGS. 1 to 3, respectively. The header 10 is made to attach and detach from a conventional forage harvester 11, as shown in FIGS. 7 and 8. The header 10 has an open front side 12, a platform 13 across a bottom side, and a rear discharge opening 14 at a center portion of the header 10 for passing crop material rearwardly into the forage harvester 11. The forage harvester 11 includes a robust cutting mechanism 15 for chopping crop material received from the rear discharge opening 14 of the header 10 and conveying the chopped crop material through a chute 16 for discharge into a transport vehicle (not shown).

The header 10 includes a plurality of rotary cutters 17 arranged side-by-side across a front side of the platform 13. The rotary cutters 17 each have two cutting blades 18 that protrude outwardly from a spinning disc 19. The spinning disc 19 provides a relatively smooth top surface to facilitate the flow of crop material over the rotary cutters 17 into the header 10.

The rotary cutters 17 are rotationally offset relative to one another so that the cutting blades 18 of adjacent rotary cutters 17 do not hit each other as they rotate. The cutting blades 18 rotate in a generally horizontal plane that slopes slightly downwardly at the front. That is, the rotary cutters 17 are arranged so that a front side of a cutting path 20 of the blades 18 is slightly lower than a rear side of the path of the blades 18.

A first auger 21 is arranged for conveying crop material cut by the rotary cutters 17 from an outer portion of the header 10 toward the center portion thereof. The first auger 21 is rotatably driven about a first generally transverse horizontal axis. The first auger 21 comprises a cylindrical-shaped member 22 with helical flighting 23 on its outer surface for moving crop material toward the center portion of the header 10. A plurality of teeth bars 24 are positioned around a center section of the cylindrical-shaped member 22 for feeding cut crop material into the rear discharge opening 14 of the header 10.

A roller 25 is supported at a front side of the header 10 and extends across a width of the header 10 for engaging and bending standing crop material as the crop material enters the header 10. The roller 25 is a cylindrical member supported at its ends by bearings 26, 27 that allow the roller 25 to rotate about a generally transverse horizontal axis. The roller 25 is adjustable in height relative to the rotary cutters 17 to accommodate different crop conditions.

A crop gathering arm assembly 28 is positioned in front of the roller 25 to help guide standing crop material into the header 10. The arm assembly 28 has a generally transverse center portion 29 and right and left arm portions 30, 31 that extend outwardly and forward from respective ends of the center portion 29 to guide standing crop material into the header 10. The crop gathering arm assembly 28 is adjustable in height to accommodate different crop conditions.

A second auger 32 is arranged in front of the first auger 21 to prevent bunching of crop material in front of the rotary cutters 17. The second auger 32 is rotatably driven about a second generally transverse horizontal axis spaced in front of the first axis. The second auger 32 has auger flighting 33 for moving crop material toward the center portion of the header 10, and a plurality of teeth bars 34 positioned around a center section of the second auger 32 for guiding the crop material rearwardly to the center section of the first auger 21.

An adjustable support frame 35 is pivotally mounted to the header 10 for supporting the roller 25, crop gathering arm assembly 28, and second auger 32. The support frame 35 includes a rocker shaft 36 that extends across a front side of the header 10 and is supported at its ends by first and second sleeve members 37, 38 and at its middle by a third sleeve member 39. A plurality of support arms 40, 41, 42, 43 are fixed to the rocker shaft 36 and extend radially outwardly from the rocker shaft 36. A pair of hydraulic actuators 44, 45 are connected between the main frame 46 of the header 10 and two of the support arms 40, 43. The hydraulic actuators 44, 45 can be selectively extended and contracted to pivot the support arms 40-43 about the transverse axis of the rocker shaft 36.

The center portion 29 of the crop gathering arm assembly 28 is rotationally supported within sleeves 47 that are fixed to the front ends of the support arms 40-43. A pair of parallel linkage assemblies 48 are connected between the main frame 46 of the header 10 and the center portion 29 to maintain the crop gathering arm assembly 28 in a substantially horizontal position as it is raised and lowered by the pivoting action of the support arms 40-43 about the axis of the rocker shaft 36.

Right and left roller support frames 49 are connected to the respective ends of the center portion 29 of the crop gathering arm assembly 28 for supporting the roller 25. The roller support frames 49 each have a roller support arm 50 and an adjustment plate 51 with a plurality of mounting holes 52 that allow the roller support arm 50 to be adjusted relative to the crop gathering arm assembly 28. As shown in FIG. 4, the roller support arm 50 can be adjusted to a plurality of different positions by using different mounting holes 52 on the adjustment plate 51.

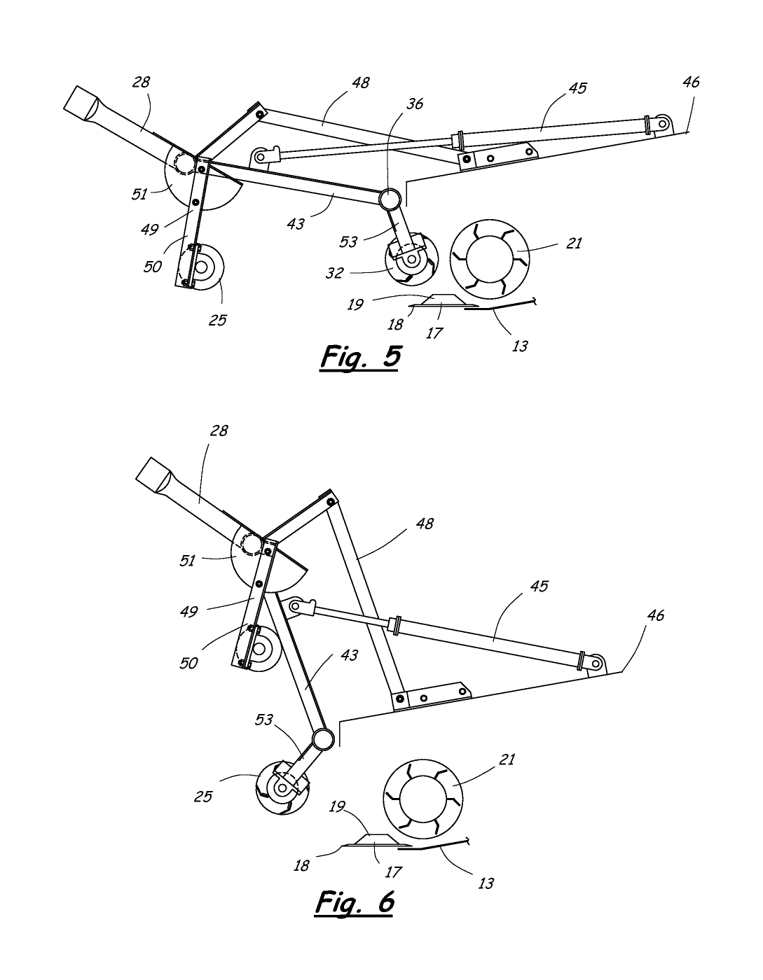

The second auger 32 can also be supported by support arms 53 that are fixed to and extend from the rocker shaft 36. The support arms 53 for the second auger 32 extend radially outwardly from the rocker shaft 36 in a direction that allows the second auger 32 to be positioned in front of the first auger 21 and generally above the rotary cutters 17. As shown in FIGS. 5 and 6, the position of the second auger 32 relative to the first auger 21, as well as the height of the roller 25 and the crop gathering arm assembly 28 relative to the rotary cutters 17, can be adjusted using the hydraulic actuators 44, 45 to accommodate different crop conditions.

A hydraulic power unit 60 is provided on the header 10 for receiving power from a driveshaft of the forage harvester 11. The hydraulic power unit 60 produces and supplies hydraulic power to a plurality of hydraulic motors on the header 10. For example, a first hydraulic motor (or pair of motors) 61 can be used to drive the rotary cutters 17, a second hydraulic motor 62 can be used to drive the first auger 21, and a third hydraulic motor 63 can be used to drive the second auger 32. The hydraulic power unit 60 can also be used to supply hydraulic power to the hydraulic actuators 44, 45 for raising and lowering the adjustable support frame 35. Conventional valves, flow regulators and circuitry (not shown) can be used with the hydraulic power unit 60 to achieve the desired controls and operating speeds for the header 10.

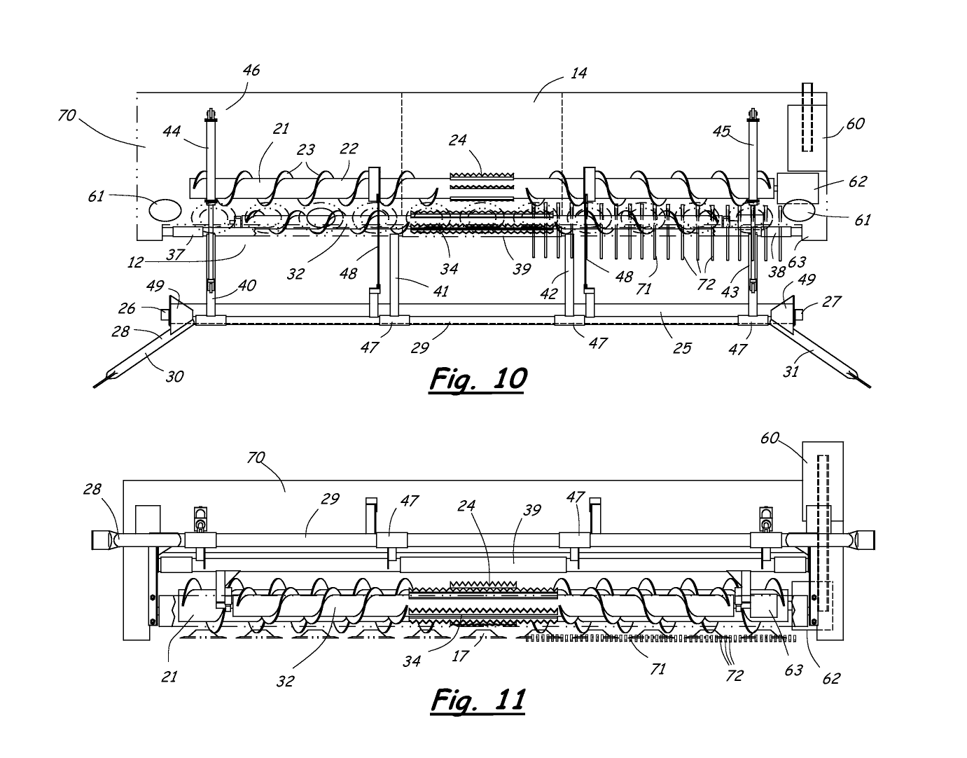

A forage harvester header 70 according to another embodiment of the present invention is illustrated in FIGS. 10 to 13. Most of the components of this header 70 are the same as those of the first header 10 described above and are labeled with the same reference numerals. The main difference between this header 70 and the first header 10 is that a guard assembly 71 is installed across the front of the header 70 to cause crop material to float over the rotary cutters 17 as it moves into the header 70.

During field trials with the forage harvester header 10, it was discovered that under some conditions the rotary cutters 17 would hit ears of corn passing into the header and knock them back out into the field. The guard assembly 71 shown in FIGS. 10 to 13 was added to the header 70 to overcome this problem. The guard assembly 71 functions to keep corn ears and the like from hitting the rotary cutters 17 and being propelled back out of the header 70. Instead, the corn ears and the like will float over the guard assembly 71 and into the augers 21, 32 without coming into direct contact with the rotary cutters 17.

The guard assembly 71 has a plurality of teeth structures 72 that are attached under the platform 13 of the header 70. Each tooth structure 72 is made of high strength, heat-treated metal (e.g., ¾ inch diameter rod) and can be individually mounted and replaced. Each tooth structure 72 has a bottom portion 73 that extends horizontally from its attachment point forward of the platform 13, and a top portion 74 that extends rearwardly and upwardly from an apex 75 at a front end of the tooth structure 72. The teeth structures 72 are spaced approximately 2 to 4 inches apart across the width of the header 70 (only a portion of the teeth structures 72 are illustrated in FIGS. 10 to 13). The guard assembly 71 can be easily removed from and reattached to the header 70 so that the header 70 can be quickly and easily adapted to accommodate a variety of crop conditions.

While the invention has been specifically described in connection with specific embodiments thereof, it is to be understood that this is by way of illustration and not of limitation, and the scope of the appended claims should be construed as broadly as the prior art will permit.

What is claimed is:

1. A header for a forage harvester, comprising:
a plurality of rotary cutters arranged side-by-side across a front side of a platform, said platform having a rear discharge opening at a center portion of the header for passing crop material to a chopper mechanism;
a first auger arranged for conveying crop material cut by the rotary cutters from an outer portion of the header toward the center portion thereof, said first auger being rotatably driven about a first generally transverse horizontal axis; and
a roller supported at a front side of the header and extending across a width of the header for engaging and bending standing crop material as the crop material enters the header.

2. The header according to claim 1, wherein said rotary cutters each comprises a blade that rotates in a generally horizontal plane with a front side of a cutting path of the blade being slightly lower than a rear side of the cutting path.

3. The header according to claim 2, wherein said rotary cutters each comprises a disc and two cutting blades protruding radially outwardly from the disc, and wherein said rotary cutters are rotationally offset relative to one another so that the cutting blades of adjacent rotary cutters do not hit each other.

4. The header according to claim 1, further comprising a second auger arranged in front of said first auger for moving crop material toward the center portion of the header to prevent bunching of crop material in front of the rotary cutters, said second auger being rotatably driven about a second generally transverse horizontal axis spaced in front of said first axis.

5. The header according to claim 1, wherein said roller is a cylindrical member supported at its ends by bearings that allow the roller to rotate about a generally transverse horizontal axis.

6. The header according to claim 1, wherein said first auger comprises a cylindrical-shaped member with helical flighting on its outer surface for moving crop material toward the center portion of the header, and a plurality of teeth bars positioned around a center section of the cylindrical-shaped member for feeding cut crop material into the rear discharge opening of the header.

7. The header according to claim 1, wherein said roller is adjustable in height relative to the rotary cutters to accommodate different crop conditions.

8. The header according to claim 1, further comprising a crop gathering arm assembly positioned in front of said roller, said arm assembly having a generally transverse center portion and right and left arm portions that extend outwardly and forward from respective ends of the center portion to guide standing crop material into the header.

9. The header according to claim 8, wherein said crop gathering arm is adjustable in height to accommodate different crop conditions.

10. The header according to claim 9, wherein said roller and said crop gathering arm are mounted on an adjustable support frame and are adjustable in height relative to the rotary cutters to accommodate different crop conditions.

11. The header according to claim 10, further comprising a second auger arranged in front of said first auger for moving crop material toward the center portion of the header to prevent bunching of crop material in front of the rotary cutters, said second auger being rotatably driven about a second generally transverse horizontal axis spaced in front of said first axis of said first auger.

12. The header according to claim 11, wherein said second auger is mounted on said adjustable support frame so as to be adjustable together with said roller and said crop gathering arm relative to the rotary cutters to accommodate different crop conditions.

13. The header according to claim 1, further comprising a hydraulic power unit that receives power from a driveshaft and supplies hydraulic power to a plurality of hydraulic motors on the header for driving the rotary cutters and the first auger.

14. The header according to claim 1, further comprising a guard assembly having a plurality of forward extending teeth structures spaced across a front of the header to cause crop material to pass over the rotary cutters.

15. In combination, a forage harvester and a header, the forage harvester having a mechanism for chopping crop material gathered by the header and conveying the chopped crop material into a transport vehicle, the header comprising:
a plurality of rotary cutters arranged side-by-side across a front side of a platform, said platform having a rear discharge opening at a center portion of the header for passing crop material to a chopper mechanism;
a first auger arranged for conveying crop material cut by the rotary cutters from an outer portion of the header toward the center portion thereof, said first auger being rotatably driven about a first generally transverse horizontal axis; and
a roller supported at a front side of the header and extending across a width of the header for engaging and bending standing crop material as the crop material enters the header.

16. The combination according to claim 15, wherein said header further comprises a second auger arranged in front of said first auger for moving crop material toward the center portion of the header to prevent bunching of crop material in front of the rotary cutters, said second auger being rotatably driven about a second generally transverse horizontal axis spaced in front of said first axis.

17. The combination according to claim 15, wherein said roller is a cylindrical member supported at its ends by bearings that allow the roller to rotate about a generally transverse horizontal axis.

18. The combination according to claim 15, wherein said first auger comprises a cylindrical-shaped member with helical flighting on its outer surface for moving crop material toward the center portion of the header, and a plurality of teeth bars positioned around a center section of the cylindrical-shaped member for feeding cut crop material into the rear discharge opening of the header.

19. The combination according to claim 15, wherein said header further comprises a crop gathering arm assembly positioned in front of said roller, said arm assembly having a generally transverse center portion and right and left arm portions that extend outwardly and forward from respective ends of the center portion to guide standing crop material into the header.

20. The combination according to claim 15, wherein said crop gathering arm is adjustable in height to accommodate different crop conditions.

21. The combination according to claim 20, wherein said roller and said crop gathering arm are mounted on an adjustable support frame and are adjustable in height relative to the rotary cutters to accommodate different crop conditions.

22. The combination according to claim 21, wherein said header further comprises a second auger arranged in front of said first auger for moving crop material toward the center portion of the header to prevent bunching of crop material in front of the rotary cutters, said second auger being rotatably driven about a second generally transverse horizontal axis spaced in front of said first axis of said first auger.

23. The combination according to claim 22, wherein said second auger is mounted on said adjustable support frame so as to be adjustable together with said roller and said crop gathering arm relative to the rotary cutters to accommodate different crop conditions.

24. The combination according to claim 15, wherein said roller is adjustable in height relative to the rotary cutters to accommodate different crop conditions.

25. The combination according to claim 15, wherein said header further comprises a hydraulic power unit that receives power from a driveshaft of said forage harvester and supplies hydraulic power to a plurality of hydraulic motors on the header for driving the rotary cutters and the first auger.

26. The combination according to claim 15, further comprising a guard assembly having a plurality of forward extending teeth structures spaced across a front of the header to cause crop material to pass over the rotary cutters.
